(19) United States
(12) Patent Application Publication
(10) Pub. No.: US 2012/0155726 A1
(43) Pub. Date: Jun. 21, 2012

(54) METHOD AND SYSTEM OF DETERMINING A GRADE OF NUCLEAR CATARACT

(76) Inventors: Huiqi Li, Singapore (SG); Joo Hwee Lim, Singapore (SG); Jiang Jimmy Liu, Singapore (SG); Wing Kee Damon Wong, Singapore (SG); Ngan Meng Tan, Singapore (SG); Zhuo Zhang, Singapore (SG); Shijian Lu, Singapore (SG); Tien Yin Wong, Singapore (SG)

(21) Appl. No.: 13/392,508

(22) PCT Filed: Aug. 24, 2009
(86) PCT No.: PCT/SG09/00297

§ 371 Date: Feb. 24, 2012

(51) Int. Cl. G06K 9/48; G06K 9/62

(52) U.S. Cl. 382/128

(57) ABSTRACT

A method for determining a grade of nuclear cataract in a test image. The method includes: (1a) defining a contour of a lens structure in the test image, the defined contour of the lens structure comprising a segment around a boundary of a nucleus of the lens structure; (1b) extracting features from the test image based on the defined contour of the lens structure in the test image; and (1c) determining the grade of nuclear cataract in the test image based on the extracted features and a grading model.

### FIELD OF THE INVENTION

The present invention relates to a method and system for determining a grade of cataract in a slit-lamp image. The method and system is preferably used to determine the grade of nuclear cataract.

### BACKGROUND OF THE INVENTION

The number of blind people worldwide is projected to reach 76 million by the year 2020 [1]. Statistics have shown that cataract causes half of the blindness throughout the world. Some possible risk factors for cataract development have been suggested but to date, there is no confirmed method to prevent cataract formation. However, nearly normal visual function can be restored by cataract surgery with the use of an intraocular lens. To prevent vision loss, accurate diagnosis and timely treatment of cataract are essential.

Cataract is the clouding or opacity of the lens inside the eye. The first sign of cataract is usually a loss of clarity or blurring. There are three main types of age-related (senile) cataract, namely the nuclear cataract, cortical cataract and posterior subcapsular cataract. These are defined by their clinical appearances, for example the locations of the opacities of the lens inside the eyes. Nuclear cataract forms in the center of the lens of the eye, cortical cataract forms in the lens cortex of the eye whereas posterior subcapsular cataract begins at the back of the lens of the eye. Nuclear cataract is the most common among the three types of cataract. Clinically, nuclear cataract is diagnosed via slit-lamp assessment where a grade is assigned to provide a quantitative record of cataract severity by comparing the slit-lamp image against standard photos. These clinical classification methods are subjective and are also time-consuming especially when used for a population study.

Automatic diagnosis of nuclear cataract using slit-lamp images has been investigated by several research groups. The Wisconsin group [2-3] proposed a method which extracts anatomical structures on the visual axis, selects the sulcus intensity and the intensity ratio between the anterior and posterior lentil as features and performs linear regression for automatic grading of nuclear sclerosis. The John Hopkins group [4] proposed a method which analyzes the intensity profile on the visual axis and extracts three features, namely, the nuclear mean gray level, the slope at the posterior point of the profile and the fractional residual of the least-square fit. A neural network is then trained using these features to determine the grade of nuclear opacification. Both the studies performed by the Wisconsin group and the John Hopkins group only utilize the features on the visual axis whereas the whole area of the lens nucleus is usually analyzed in the clinical diagnosis of nuclear cataract. The inventors themselves have also previously proposed a method for automatic diagnosis of nuclear cataract [5-6] which extracts the contour of the lens. However, the inventors have previously analyzed the whole lens area rather than only the nucleus area and have found that this results in an inaccurate assessment. None of the previous studies performed by the Wisconsin group, the John Hopkins group or even the inventors themselves has been validated using a large amount of clinical data.

### SUMMARY OF THE INVENTION

The present invention aims to provide a new and useful automatic method and system for determining a grade of nuclear cataract in a test image.

In general terms, the present invention proposes defining a contour of a lens structure in the image which comprises a segment around a boundary of a nucleus of the lens structure. This contour can then be used for determining the grade of nuclear cataract in the image. Such a contour is preferable as the nucleus region is usually the only region in which nuclear cataract is normally assessed.

Specifically, a first aspect of the present invention is a method for determining a grade of nuclear cataract in a test image, the method comprising the steps of: (1a) defining a contour of a lens structure in the test image, the defined contour of the lens structure comprising a segment around a boundary of a nucleus of the lens structure; (1b) extracting features from the test image based on the defined contour of the lens structure in the test image; and (1c) determining the grade of nuclear cataract in the test image based on the extracted features and a grading model.

The invention may alternatively be expressed as a computer system for performing such a method. This computer system may be integrated with a device for capturing slit-lamp images. The invention may also be expressed as a computer program product, such as one recorded on a tangible computer medium, containing program instructions operable by a computer system to perform the steps of the method.

### BRIEF DESCRIPTION OF THE FIGURES

An embodiment of the invention will now be illustrated for the sake of example only with reference to the following drawings, in which:

FIG. 1 illustrates a flow diagram of a method 100 which performs an automatic grading of nuclear cataract according to an embodiment of the present invention, the method 100 comprising steps 102-108 and 112-118.

FIG. 2 illustrates a flow diagram of sub-steps 102a-102d of step 102 of method 100 of FIG. 1;

FIG. 3 illustrates horizontal and vertical lines in an image whereby the profiles of these horizontal and vertical lines are analyzed in step 102 of method 100 of FIG. 1;

FIG. 4 illustrates landmark points on a shape model describing a lens structure in an image;

FIG. 5 illustrates a flow diagram of sub-steps 104bi-104bii of sub-step 104b of step 104 of method 100 of FIG. 1;

FIG. 6 illustrates results of steps 102 to 104 of method 100; and

FIG. 7 illustrates the differences between the results of method 100 and the grading performed by a clinical grader.

### DETAILED DESCRIPTION OF THE EMBODIMENTS

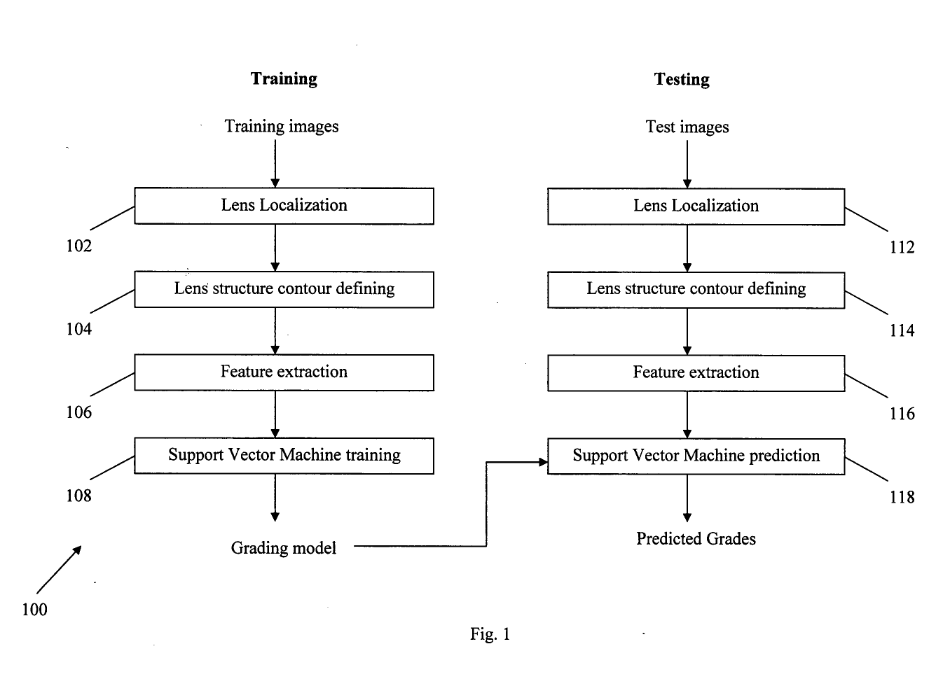

Referring to FIG. 1, the steps are illustrated of a method 100 which is an embodiment of the present invention, and which performs an automatic grading of nuclear cataract. By the word “automatic”, it is meant that once initiated by a user, the entire process in the present embodiment is run without human intervention. Alternatively, the embodiments may be performed in a semi-automatic manner, that is, with minimal human intervention.

The input to the method 100 is a series of training slit-lamp images and test slit-lamp images. Method 100 comprises two phases: the training phase comprising steps 102-108 and the testing phase comprising steps 112-118. All the slit-lamp images are obtained from different eyes. For every subject, two slit-lamp images (one from each eye of the subject) are obtained.

Training images are used in the training phase. In the training phase, step 102 is first performed to localize the lens in each of the training images and this is followed by step 104 which is performed to define the contour of the lens structure in each of the training images. Next, step 106 is performed to extract features from each of the training images based on the defined lens structure contour in step 104. Step 108 is then performed to train a Support Vector Machine (SVM) based on the extracted features from step 106 to obtain a grading model.

Test images are used in the testing phase. For each test image, steps 112, 114 and 116 are respectively performed to localize the lens in the image, define the lens structure contour in the image and extract features from the image based on the defined lens structure contour. The sub-steps in steps 112, 114 and 116 are the same as the sub-steps in steps 102, 104 and 106 respectively. Next, a SVM prediction is performed using the extracted features from step 116, and the grading model obtained from step 108 to obtain a grade for each of the test images. This grade is a quantitative indication of the severity of nuclear cataract in the lens of the test image.

### Training Phase

### Step 102: Lens Localization in Training Images

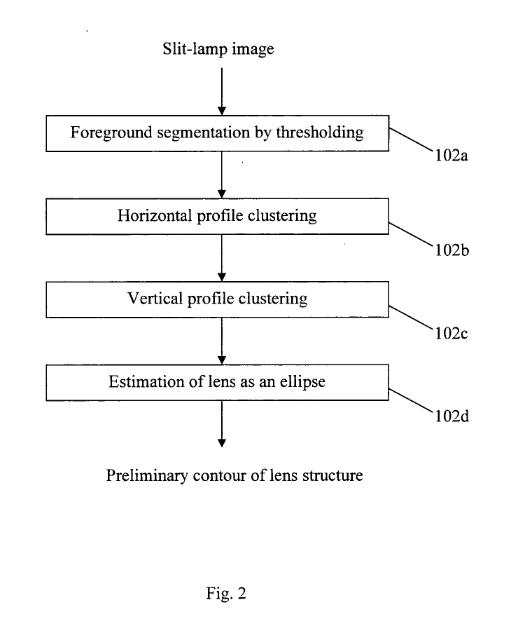

Step 102 localizes the lens in each slit-lamp training image. Referring to FIG. 2, the sub-steps of step 102 are shown.

When one observes a slit-lamp image, one can usually see the corneal bow as the leftmost (for right eye) or rightmost (for left eye) bright vertical curve in the image whereas the lens is usually the largest part in the foreground which occupies approximately 20% to 30% of an entire slit-lamp image. Furthermore, the lens usually appears in the center of the image. In sub-step 102a, a threshold is first set to segment the brightest 20% to 30% of the pixels in the grey image of the slit-lamp image to segment the foreground. The brightest pixels are pixels having the highest grey level values

Next, a localization scheme is performed on the foreground of the image segmented in sub-step 102a to localize the lens. The localization scheme comprises sub-steps 102b-102d.

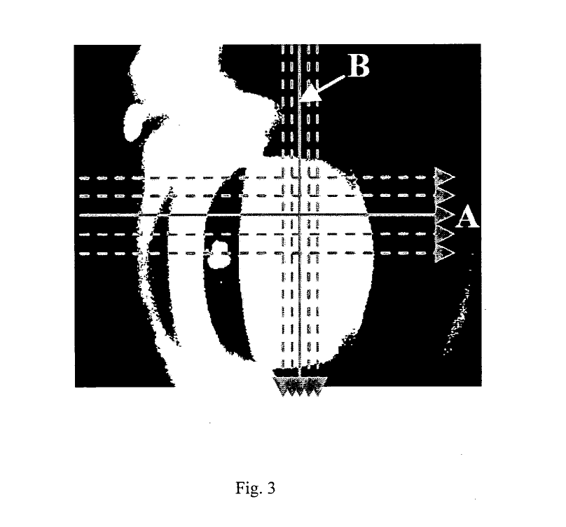

In sub-step 102b, a plurality of horizontal lines in the image is first obtained. The plurality of lines comprises a median horizontal line and four lines parallel to the median horizontal line. A horizontal profile clustering is then performed in which the horizontal profiles through the median horizontal line of the image and the four lines parallel to the median horizontal line are analyzed. A profile through a line is defined as the intensity profile of the image through the line. In FIG. 3, the median horizontal line labeled as line A and the four lines parallel to line A (two above line A and two below line A) are shown. For each horizontal profile, clustering is performed and the centroid of the largest cluster is determined. The horizontal coordinate of the lens center is estimated as the mean of the horizontal coordinates of the centroids determined for the horizontal profiles. The number of pixels in the largest cluster for each profile is referred to as the cluster size. In the localization scheme, the cluster size for each horizontal profile is determined and the horizontal diameter of the lens is estimated as the mean of the cluster size of the horizontal profiles.

In sub-step 102c, a plurality of vertical lines in the image is first obtained. The plurality of vertical lines comprises a vertical line through the estimated horizontal coordinate of the lens center obtained from sub-step 102b and four lines parallel to this vertical line. A vertical profile clustering is then performed on these lines. In FIG. 3, the vertical line through the estimated horizontal coordinate of the lens center is labeled as line B and is shown together with the four lines parallel to line B (two on the left of line B and two on the right of line B). Similarly, for each vertical profile, clustering is performed and the centroid of the largest cluster is determined. The vertical coordinate of the lens center is estimated to be the mean of the centroids determined for the vertical profiles. The cluster size is also determined for each vertical profile and the vertical diameter of the lens is estimated as the mean of the cluster size for the vertical profiles.

The coordinates of the estimated lens center (also referred to as the localization center) obtained using sub-steps 102b and 102c are denoted as (Lₓ, L_{y}) where Lₓ, L_{y} are the horizontal and vertical coordinates of the estimated lens center respectively. In sub-step 102d, the lens is then estimated as an ellipse centered on the localization center with horizontal and vertical diameters equal to the estimated horizontal and vertical diameters of the lens obtained in sub-steps 102b and 102c. This ellipse is a preliminary contour of the lens structure.

### Step 104: Lens Structure Contour Defining in Training Images

In step 104, the contour of the lens structure (and its nucleus) is defined by first obtaining a point distribution model (PDM) in sub-step 104a and then applying a modified Active Shape Model (ASM) method [7] in sub-step 104b.

Sub-Step 104a: Obtaining the Point Distribution Model

The PDM is obtained by learning patterns of variability from a training set of correctly annotated images and thus allows deformation in certain ways that are consistent with the training set.

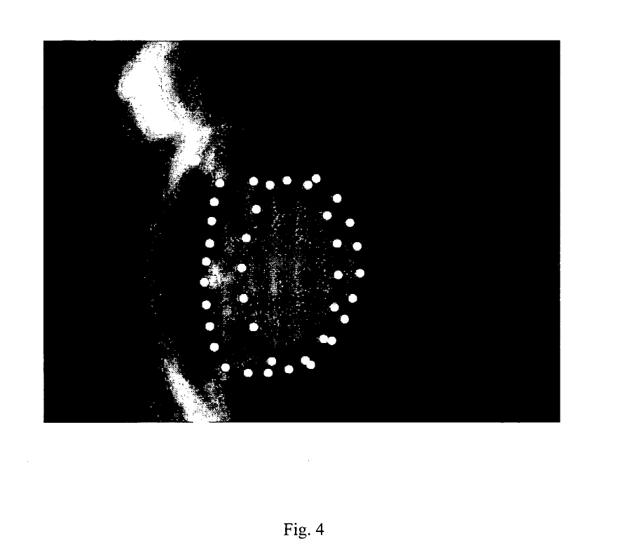

In sub-step 104a, a total of n=38 landmark points as illustrated in FIG. 4 is used to describe the shape of a lens. Besides the lens contour described in previous models [5-6], the contour of the lens nucleus is also included in the thirty-eight point distribution model as shown in FIG. 4.

A sub-set of images from the training images are used as images in the training set for sub-step 104a. In sub-step 104a, the n=38 landmark points are first labeled manually on the images in the training set, forming a shape on each image in the training set. The shapes on the different images (referred to as the training shapes) are then aligned to a common coordinates system using a transformation which minimizes the sum of squared distances between the manually labeled landmark points on different training shapes. Principal component analysis is next performed on the aligned training shapes to derive the PDM according to Equation (1) which describes the approximated lens shape. In Equation (1), x̅ denotes the mean shape of the aligned training shapes, b=(b₁,b₂, . . . bₜ)^{T} is a vector of shape parameters, Φ=(Φ₁, Φ₂, . . . Φₜ) εR^{2n×t} is a set of eigenvectors corresponding to the largest t eigenvalues of the covariance matrix of the training shapes. The PDM is referred to as the initial shape model and is subsequently used in the modified ASM in sub-step 104b.

x= x̅+Φb (1)

In sub-step 104a, ten images are used in the training set, n is set to 38 and t is set to 4 (i.e. the first 4 eigenvectors corresponding to the largest 4 eigenvalues of the covariance matrix of the training shapes are used in Equation (1) to describe the approximated lens shape). These first 4 eigenvectors represent 90.5% of the total variance of the shapes in the training set. Alternatively, the number of images used in the training set and the values of n and t may be changed.

Sub-Step 104b: Applying a Modified ASM Method

The ASM method is an iterative refinement procedure which deforms the shape model only in ways that are consistent with the training shapes. The ASM method is used to fit the shape model to a new image to find the modeled object, in this case the lens of the eye, in the new image. The space defined by the new image is referred to as the image space whereas the space described by Equation (1) is referred to as the shape space. The transform between the shape space and the image space can be described according to Equation (2) where the shape model in the shape space and in the image space is denoted by x and X respectively, the coordinates (xᵢ, yᵢ) denote the position of the i^{th} landmark point of the shape model in the shape space whereas the coordinates (tₓ,t_{y}) denotes the position of the shape model center in the image space.

$$X = T ( x ) = ( \begin{matrix}s cos θ & - s sin θ \\ s sin θ & s cos θ\end{matrix} ) ( \begin{matrix}{x}_{i} \\ {y}_{i}\end{matrix} ) + ( \begin{matrix}{t}_{x} \\ {t}_{y}\end{matrix} ) \qquad ( 2 )$$

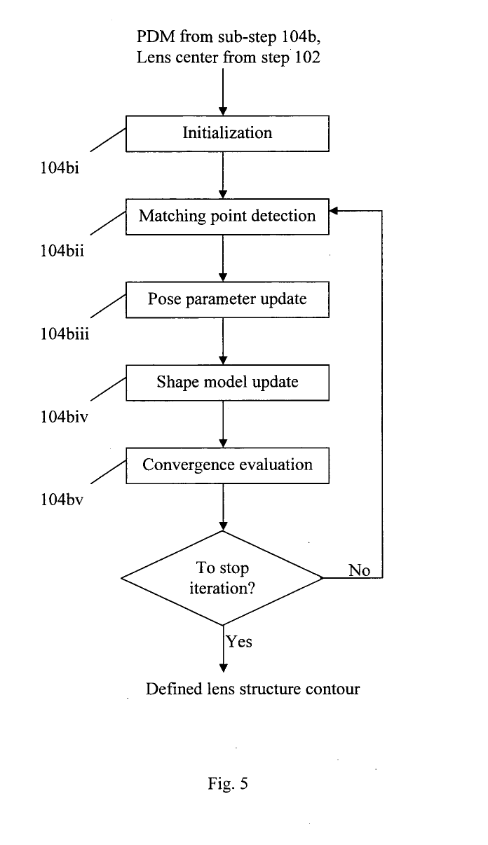

In sub-step 104b, the modified ASM method comprises five further sub-steps namely, the initialization step (sub-step 104bi), the matching point detection step (sub-step 104bii), the pose parameter update step (sub-step 104biii), the shape model update step (sub-step 104biv) and the convergence evaluation step (sub-step 104bv) as shown in FIG. 5. Sub-steps 104bii to 104bv are repeated and the outcome of the convergence evaluation step (sub-step 104bv) is used to determine if the iteration should continue.

### Sub-step 104bi

The initialization step (sub-step 104bi) of the modified ASM method is used to place the initial shape model to a proper starting position in the image space and is essential since ASM methods only search for matching points around a current shape model in the image space. In sub-step 104bi, a proper pose parameter vector τ(s,θ,tₓ,tᵥ) and a shape parameter vector b are set. This is automatically performed by employing the estimated lens center obtained in step 102 and the PDM obtained in sub-step 104a to initialize the parameters as follows: bᵢ=0, i=1˜t, x= x̅, θ=0, tₓ=Lₓ,t_{y}=L_{y}. The scaling factor s is determined using the semi-axes radii of the ellipse estimated in step 102. This creates a first deformed shape model in the image space, with a series of image landmark points.

### Sub-Step 104bii

In the matching point detection step (sub-step 104bii) of step 104, for each image landmark point on the shape model in the image space, a matching point is located and the image landmark point is moved to the located matching point. The search for the matching point for each image landmark point is performed along a profile normal to the boundary of the shape model on the image and passing through the image landmark point (referred to as normal profile). This is performed using the first derivative of the intensity distribution of the image along the normal profile to locate a point on the edge of the lens structure in the image as the matching point for the image landmark point. For some image landmark points, the matching points cannot be located using the first derivative of the intensity distribution of the image along the normal profile and the matching points for these image landmark points are estimated from nearby matching points of surrounding image landmark points. The original image landmark points will be used as the matching points for those image landmark points whose matching points cannot be estimated by the nearby matching points either.

Sub-step 104biii

In the pose parameter update step (sub-step 104biii) of step 104, a self-adjusting weight transform is used to find a pose parameter vector τ(s,θ,tₓ,t_{y}), by minimizing a weighted sum of squares measure of the differences between the image landmark points of the shape model in the image space and their matching points. This is performed by setting

$$\frac{\partial {E}_{τ}}{\partial τ} = 0 ,$$

where E_{τ} is defined according to Equation (3). In Equation (3), Yᵢ and Xᵢ are the positions of the i^{th} point in the matching points set and in the deformed shape model in the image space respectively, xᵢ is the shape model in the shape space and W is the weight factor.

$${E}_{τ} = {\sum }_{i = 1}^{n} {( {Y}_{i} - {X}_{i} )}^{T} {W}_{i} ( {Y}_{i} - {X}_{i} ) = {\sum }_{i = 1}^{n} {( {Y}_{i} - T ( {x}_{i} ) )}^{T} {W}_{i} ( {Y}_{i} - T ( {x}_{i} ) ) \qquad ( 3 )$$

In each iteration of the modified ASM method performed in step 104, the transformation of the shape model from the shape space onto the image space is performed twice to obtain the updated pose parameter. The first transformation is performed using initial weight factors Wᵢ and the second transformation is performed using adjusted weight factors Wᵢ.

The initial weight factors Wᵢ are assigned according to how the i^{th} matching point is obtained. A larger Wᵢ is assigned to the matching points detected directly along the normal profile (i.e. lies on the normal profile) whereas a smaller Wᵢ is assigned to the remaining matching points estimated from the nearby matching points. In one example, the Wᵢ is further set to zero for matching points estimated as the original image landmark points. Using the initial weight factors Wᵢ, a preliminary update of the pose parameter vector τ(s,θ,tₓ,t_{y}) is calculated using Equation (3) and is used to transform the shape model in the shape space to the image space. This is the first transformation and a preliminary deformed shape model in the image space with updated image landmark points is obtained from this first transformation.

The adjusted weight factors Wᵢ are then set as the piece-wise reciprocal ratio of the Euclidean distance between the i^{th} matching point and the i^{th} updated image landmark point in the image space obtained from the first transformation. The pose parameter vector is again updated using the adjusted weight factors Wᵢ according to Equation (3) using the updated image landmark points from the first transformation and the final updated pose parameter vector is used to transform the shape model in the shape space onto the image space again. This is the second transformation.

### Sub-Step 104biv

In the shape model update step (sub-step 104biv) of the modified ASM method, the matching points in the image space are transformed onto the shape space using the final updated pose parameter τ(s,θ,tₓ,t_{y}) obtained in sub-step 104biii. The shape parameter vector is then updated by projecting the transformed matching points onto the shape space according to Equation (4) where b ε R^{t}, \tilde{Φ}^{T} ε R²⁽ⁿ⁻ⁿ^{ₘ}^{)×t}, \tilde{y} ε R²⁽ⁿ⁻ⁿ^{ₘ}⁾ and \overline{\tilde{x}}ε R²⁽ⁿ⁻ⁿ^{ₘ}⁾. \tilde{y} is the transformed matching points set in the shape space excluding nₘ misplaced matching points (to be elaborated below) whereas \tilde{Φ}, \overline{\tilde{x}} are the eigenvectors and mean shape in the 2(n−nₘ) dimensional space corresponding to \tilde{Φ} and x̅ respectively.

b=\tilde{Φ}^{T}(\tilde{y}− \overline{\tilde{x})} (4)

A matching point is considered misplaced when the Euclidean distance between the matching point and a corresponding shape landmark point on a preliminary update of the shape model in the shape space is larger than a certain value. The preliminary update of the shape model in the shape space is computed using a preliminary update of the shape parameter vector which is in turn computed using Equation (4) with \tilde{y} being the entire transformed matching points set. Since the misplaced matching points can also affect the shape parameter vector b when projecting the transformed matching points onto the shape space, the misplaced matching points are excluded from the transformed matching points set \tilde{y} to get a shape parameter vector b which better fits the matching points.

The shape model in the shape space is then updated using Equation (1) by reconstructing the shape model in the 2n-Dimension (2n−D) landmark space with the updated shape parameter vector b.

### Sub-Step 104bv

In the convergence evaluation step (sub-step 104bv) of the modified ASM method, the convergence of the shape model in the image space is evaluated according to Equation (5) to determine if the iteration should continue. In Equation (5), X″ and Xⁿ⁻¹ respectively denote the deformed shape model of the n^{th} iteration and the (n−1)^{th} iteration in the image space, and ε_{T} is a small constant value. The deformed shape model of the n^{th} iteration in the image space was previously obtained from the first and second transformations performed in sub-step 104biii in the n^{th} iteration.

In sub-step 104bv, ε_{T} is set to 10. In other words, if Eₓ is less than 10, the iteration is stopped and the deformed shape model in the image space at this iteration is taken as the defined lens structure contour and if Eₓ is greater than 10, the iteration continues. Alternatively, ε_{T} may be set to any other value.

E_{X}=∥Xⁿ−Xⁿ⁻¹∥<ε_{T} (5)

Although step 104 of method 100 which is the preferred embodiment of the present invention uses a modified ASM method for the lens structure contour defining step, the lens structure contour defining step may be performed using other algorithms such as the active contour (snakes) algorithm, the region growing algorithm and the level set algorithm.

Step 106: Feature Extraction from Training Images

In step 106, features are extracted from the image based on the defined lens structure for diagnosis. The features to be extracted are selected according to a clinical lens grading protocol [8] and the list of these features is shown in Table 1. The lens contour in Table 1 refers to the defined lens contour from step 104. This contour comprises a segment around a boundary of the nucleus of the lens structure which is referred to as the nucleus contour in Table 1. For all the features related to color, the Hue-Saturation-Value (HSV) color space is selected to represent the color information.

TABLE 1

| Feature | Description |
|---|---|
| 1 | Mean intensity inside lens contour |
| 2-4 | Mean color inside lens contour |
| 5 | Mean entropy inside lens contour |
| 6 | Mean neighborhood standard deviation inside lens contour |
| 7 | Mean intensity inside nucleus contour |
| 8-10 | Mean color inside nucleus contour |
| 11 | Mean entropy inside nucleus contour |
| 12 | Mean neighborhood standard deviation inside nucleus contour |
| 13 | Intensity ratio between nucleus and lens |
| 14 | Intensity of sulcus |
| 15 | Intensity ratio between sulcus and nucleus |
| 16 | Intensity ratio between anterior lentil and posterior lentil |
| 17-18 | Strength of nucleus edge |
| 19-21 | Color on posterior reflex |

For features 1-6 as shown in Table 1, the measurement is averaged within the contour of the lens defined by the modified ASM method in step 104. Similarly, the measurement is averaged within the region of the nucleus of the lens structure defined by the modified ASM method in step 104 for features 7-12.

The intensity distribution on a horizontal line through the central posterior reflex is used to analyze the visual axis profile of the lens. This visual axis profile is then smoothed using a low-pass Chebyshev filter. The positions of the anterior lentil edge and the posterior lentil edge are then identified by edge detection. The intensity ratio between the anterior lentil and the posterior lentil (feature 16), and the strength of the nucleus edge (features 17-18) are calculated based on the visual axis profile as obtained using the central posterior reflex. The horizontal position of the sulcus is defined as the median point of nucleus edges and the intensity of the sulcus (feature 14) is calculated. The intensity of the sulcus is an important feature in clinically deciding the grade of nuclear cataract. Other features such as the intensity ratio between sulcus and nucleus (feature 15) and the intensity ratio between nucleus and lens (feature 13) are measured for grading the severity of lens opacity. The color information on the posterior reflex (features 19-21) is extracted as well.

### Step 108: Support Vector Machine (SVM) Training

In step 108, SVM regression, a supervised learning scheme is used for the purpose of grade prediction. The training procedure of the SVM regression method can be described as an optimization problem as described by Equation (6) with the conditions in Equation (7) where xᵢ denotes the feature vector of training image i, yᵢ represents its associated grade (also referred to as label), φ( ) denotes the kernel function (the radial basis function (RBF) kernel is used here), w is the vector of coefficients, C>0 is a regularization constant, b is an offset value, ξᵢ,ξᵢ*are the slack variables for pattern xᵢ, and w is a parameter defining a grading model to be used subsequently in the SVM prediction in step 118.

$$\begin{matrix}min ( \frac{1}{2} {w}^{T} w + C {\sum }_{i = 1}^{N} {ξ}_{i} + C {\sum }_{i = 1}^{N} {ξ}_{i}^{*} ) & ( 6 ) \\ {y}_{i} - {w}^{T} φ ( {x}_{i} ) - b \leq ɛ + {ξ}_{i} \\ {w}^{T} φ ( {x}_{i} ) + b - {y}_{i} \leq ɛ + {ξ}_{i}^{*} \\ {ξ}_{i} , {ξ}_{i}^{*} \geq 0 & ( 7 )\end{matrix}$$

The features extracted in step 106 are used to form the feature vector xᵢ and this feature vector xᵢ, together with its associated grade yᵢ, is used to train the SVM in step 108 to obtain the grading model.

### Testing Phase

### Steps 112, 114 and 116: Lens Localization, Lens Structure Contour Defining and Feature Extraction for Test Images

For each test image, steps 112, 114 and 116 are respectively performed to localize the lens in the image, define the lens structure contour in the image and extract features from the image based on the defined lens structure contour. The sub-steps in steps 112, 114 and 116 are the same as the sub-steps in steps 102, 104 and 106 respectively. However, in step 114, only steps corresponding to sub-step 104b (Applying a modified ASM method) are performed since the PDM obtained from sub-step 104a is used in step 114 as the initial shape model.

### Step 118: Support Vector Machine Prediction for Test Images

In step 118, a SVM prediction is performed using the extracted features from step 116, and the grading model obtained from step 108 to obtain a predicted grade for each of the test images using Equation (8) where f(x) is the predicted grade obtained, φ( ) denotes the kernel function, w is the weight factor obtained from the SVM training in step 108, x is a feature vector formed from the extracted features obtained in step 116 and b is the same offset value used in Equation (7). The predicted grade f(x) is a quantitative indication of the severity of cataract in the lens of the test image with the feature vector x.

f(x)=w^{T}φ(x)+b (8)

The advantages of method 100 are described as follows.

Since method 100 performs an automatic grading of images to determine the severity of nuclear cataracts in these images, the grades obtained is more objective and reproducible as compared to grades obtained by manual clinical grading.

From sub-step 104a of method 100, a shape model which also defines a contour segment around the boundary of the nucleus in the lens is derived and is in turn used to define the lens structure contour. Hence, the defined lens structure contour also comprises a segment around a boundary of the nucleus. Since the nucleus region is the only region in which nuclear cataract is normally assessed, such a shape model is more suitable for the purpose of method 100 which is to assess the severity of cataract.

In sub-step 104b of method 100, a modified ASM was used to define the lens structure contour. The modified ASM method is advantageous as self-adjusting weights are used in the update of the pose parameter vector. This can improve the accuracy of the updated pose parameter vector and in turn improve the transformation between the shape space and the image space since lower weights are assigned to misplaced matching points. Furthermore, misplaced matching points are excluded from the matching points set used to update the shape parameter vector. Since only the well-fitted matching points are used to obtain the shape parameter vector, the updated shape model obtained using the modified ASM method will match the real boundary better than the updated shape model obtained using the original ASM method especially in cases where more than one matching point is misplaced.

In addition, two transformations were performed to transform the shape model in the shape space onto the image space and at the same time, to obtain an updated pose parameter. A first transformation is performed using initial weight factors to obtain a preliminary deformed shape model in the image space and the weight factors are adjusted, based on this preliminary deformed shape model in the image space to perform a second transformation. Such an adjustment of the weight factors serves as a negative feedback so that if a matching point is misplaced, the misplaced matching point will not affect the transformation as much as the correct matching points and in turn, a better pose parameter τ(s,θ,tₓ,t_{y}) can be obtained.

Furthermore, in method 100, more features are extracted for grading. Besides the visual axis profile analysis, other features such as the mean intensity in the nucleus and the intensity ratio between sulcus and nucleus are also included. All these features can improve the results of the grading.

In addition, method 100 can be applied in many areas. For example, method 100 can be used in clinics to grade nuclear cataract automatically using slit-lamp images. Also, method 100 can be incorporated into lens camera systems to improve the function and features of these systems.

### Experimental Results

An experiment Was performed to test method 100 using slit-lamp images from a population-based study, the Singapore Malay Eye Study. The sampled population consists of all Malays aged 40-79 living in designated study areas in the South-West of Singapore. A digital silt-lamp camera (Topcon DC-1) was used to photograph the lens through a dilated pupil. The images were saved as 24-bit color images, each with a size of 1536*2048 pixels. A total of 5820 images from 3280 subjects were tested.

The ground truth of the clinical diagnosis of nuclear cataract is obtained from a grader's grading of the test images using the Wisconsin grading system [8]. The range of the grade is from 0.1 to 5 whereby a grade of 5 indicates the most serious case of nuclear cataract.

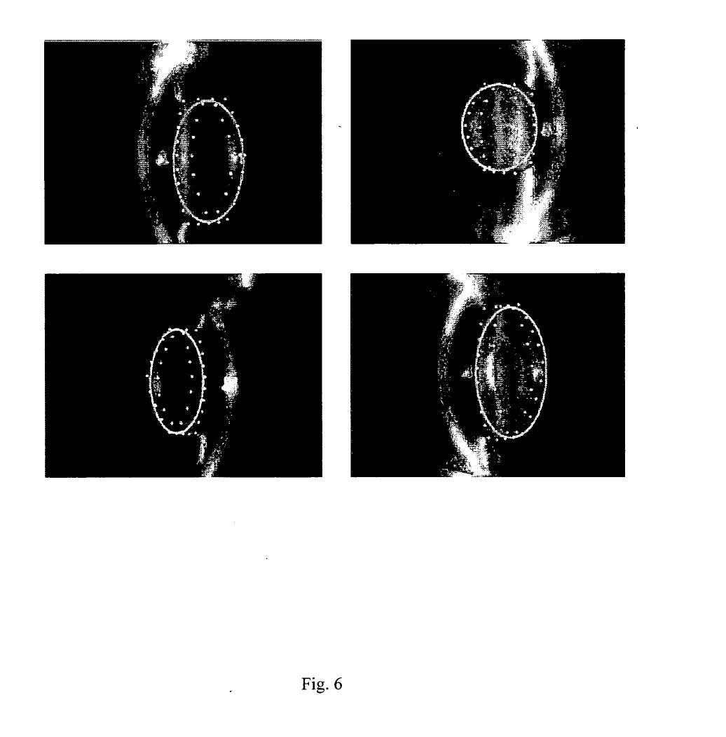

Method 100 was tested using the 5820 slit-lamp images. Some examples of the results of the lens structure contour defining step are shown in FIG. 6 in which the white dots denote the defined contour of the lens structure (including a contour around the boundary of the nucleus) from step 104 of method 100 whereas the solid line denotes the ellipse from the lens localization from step 102 of method 100. As can be seen from FIG. 6, the lens localization and lens structure contour defining steps in method 100 produce satisfactory results despite the variation in the size and location of the lens in different images.

The statistics of the feature extraction is shown in Table 2. The overlap between the automatically defined lens structure contour using method 100 and the actual lens structure contour in each image is evaluated visually. The lens structure contour defining step is assessed according to how well the automatically defined lens structure contour matches the actual lens structure contour in the image. When the overlap is between 80%-95%, the overlap is categorized as a partial detection. If the overlap is less than 80%, the overlap is categorized as a wrong detection. Successful detections are defined as those overlaps which are not partial detections or wrong detections. As the modified ASM method used in step 104 of method 100 is a local searching method, the wrong localization of the lens in step 102 will lead to a wrongly defined lens structure contour in step 104. For some images with a slightly deviated lens estimation, the modified ASM method can still converge to the contour of the lens structure. Furthermore, method 100 can achieve a success rate of 96.7% for feature extraction.

TABLE 2

| | | Lens Structure |
|---|---|---|
| | Lens | Contour |
| | Localization | Defining |
| Number of images | 5820 | 5820 |
| Number of wrong detections | 23 | 69 |
| Number of partial detections | 161 | 122 |
| Number of successful detections | 5636 | 5629 |
| Success rate | 96.8% | 96.7% |

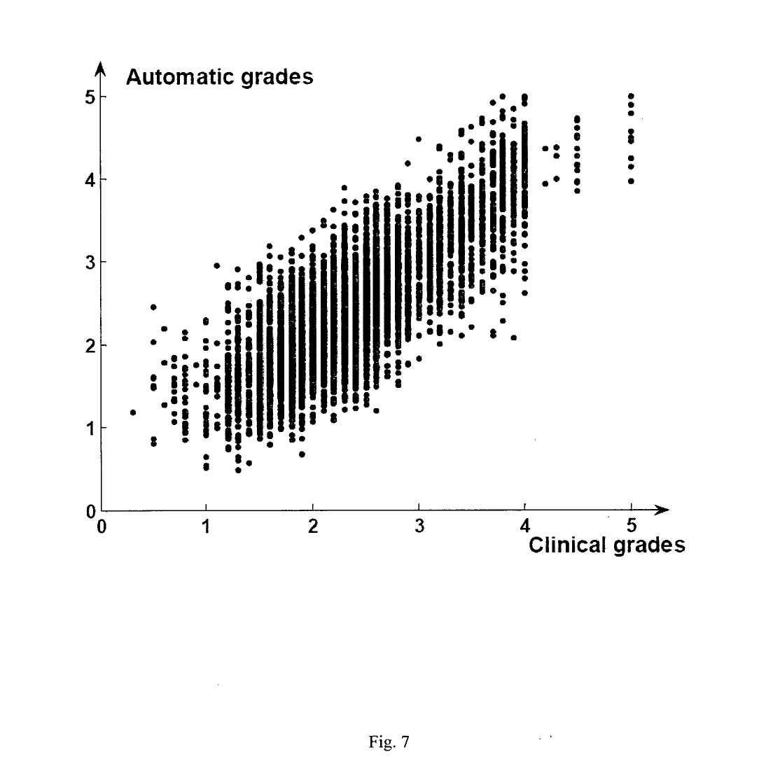

In this experiment, test images with an overlap classified as a wrong detection (a total of 69 images) were excluded during the SVM prediction step in step 118 of method 100. 161 images were marked by the clinical grader as not gradable and these images were also excluded in the SVM prediction step in step 118 of method 100. 100 images were used as the training images for step 108 of method 100. These images were classified into 5 groups according to their clinical grades (0-1, 1-2, 2-3, 3-4, 4-5) with 20 images in each group. The remaining 5490 images were used as test images and the severities of nuclear cataract in these test images were automatically diagnosed using the SVM prediction in step 118 of method 100 to predict the grades. A comparison between the grades obtained automatically from step 118 (referred to as automatic grades) and the grades from the clinical grading was performed and the results from this comparison are illustrated in FIG. 7. Taking the clinical grading as the ground truth, the mean difference between the automatic grades and the clinical grading was found to be 0.36. The differences in grades between the automatic grades and the grades from the clinical grading are tabulated in Table 3. As can be seen, the grading differences for 96.63% of the test images were found to be less than one grade difference. This is an acceptable difference in clinical diagnosis.

TABLE 3

| Difference in Grade | No. of Images | Percentage |
|---|---|---|
| 0~0.5 | 4062 | 73.99% |
| 0.5~1 | 1243 | 22.64% |
| >1 | 185 | 3.37% |

These experimental results as described above represent a strong clinical validation as the experiment was performed using a large amount of clinical data (over 5000 images with their clinical ground truth).

Comparison with Prior Arts

A comparison between the embodiments of the present invention described above, and prior arts [2-6] is summarized in Table 4.

TABLE 4

| | Nucleus region | Feature | |
|---|---|---|---|
| | detection | extraction | Limitation |
| The Wisconsin | No | Two features on | Only extracted |
| group [2-3] | | the visual axis | features on the |
| | | | visual axis |
| The John | No | Three features on | Only extracted |
| Hopkins group | | the visual axis | features on the |
| [4] | | | visual axis |
| Previous work | No | Six features on | The whole lens |
| by the inventors | | the visual axis | rather than only |
| [5-6] | | and lens region | the nucleus region |
| | | | is measured |
| Embodiments of | Yes | Twenty one | |
| the present | | features as shown | |
| invention | | in Table 1 | |

### REFERENCES

[1]. World Health Organization. State of the World's Sighting: VISION 2020: the right to Sight: 1999-2005, 2005
[2]. S. Fan, C. R. Dyer, L. Hubbard, B. Klein, “An automatic system for classification of nuclear sclerosis from slit-lamp photographs”, Proc. 6th Int. Conf. on Medical Image Computing and Computer-Assisted Intervention, LNCS, Vol. 2878, R. Ellis and T. Peters, eds., Springer, Berlin, 2003, 592-601
[3]. NJ Ferrier, “Automated Identification of the Anatomical Features in Slit Lamp Photographs of the Lens”, Invest Ophthalmol Vis Sci, Vol. 43, pp. 435, 2002.
[4]. D. D. Duncan, O. B. Shukla, “New Objective Classification System for Nuclear Opacification”, Optical Society of America, Vol. 14, No. 6, 1997
[5]. H. Li, Lim, J., Liu, J., Wong, T.-Y., Tan, A., Wang, J., Paul, M.: Image Based Grading of Nuclear Cataract by SVM Regression. In SPIE Proceeding of Medical Imaging 6915 (2008), 691536-691536-8.
[6]. H. Li, J. H. Lim, J. Liu, T. Y. Wong, “Towards Automatic Grading of Nuclear Cataract,” Proceedings of International Conference of the IEEE Engineering in Medicine and Biology Society 2007, pp. 4961-4964.
[7]. H. Li, O. Chutatape, “Boundary detection of optic disk by a modified ASM method”, Pattern Recognition, Vol. 36, No. 9, 2003, pp. 2093-2104.
[8]. B. E. K. Klein, R. Klein, K. L. P. Linton, Y. L. Magli, M. W. Neider, “Assessment of Cataracts from Photographs in the Beaver Dam Eye Study,” Ophthalmology, Vol. 97, No. 11, 1990, pp. 1428-1433.

1. A method for determining a grade of nuclear cataract in a test image, the method comprising the steps of:
(1a) defining a model of a lens structure in the test image based on the following sub-steps, the defined model of the lens structure comprising a portion indicative of a boundary of a nucleus of the lens structure in the test image
(1ai) constructing a contour around a boundary of the lens structure in the test image;
(1aii) repeatedly deforming a shape model in an iterative process to define the model of the lens structure in the test image
wherein the shape model comprises a first portion indicative of a boundary of a lens structure and a second portion indicative of a boundary of a nucleus of the lens structure in the first portion; and
wherein sub-step (1aii) comprises an initialization step of producing an initial deformed shape model on the test image by fitting the first portion of the shape modal to the constructed contour in the test image, thereby fitting the second portion of the shape model to the boundary of the nucleus of the lens structure in the test image;
(1b) extracting features from the test image based on the defined model of the lens structure in the test image, the features comprising features extracted using the portion in the defined model indicative of the boundary of the nucleus of the lens structure in the test image; and
(1c) determining the grade of nuclear cataract in the test image based on the extracted features and a grading model.

2. (canceled)

3. A method according to claim 1, wherein the grading model in step (1c) is constructed during a training phase prior to step (1a) according to the steps of:
(3a) grading nuclear cataract in a plurality of training images to determine grades of nuclear cataract in the plurality of training images;
(3b) defining a model of a lens structure in each training image based on the following sub-steps, the defined model of the lens structure comprising a portion indicative of a boundary of a nucleus of the lens structure in the training image
(3bi) constructing a contour around a boundary of the lens structure in the training image;
(3bii) repeatedly deforming the shape model in an iterative process to define the model of the lens structure in the training image;
(3c) extracting features from each training image based on the defined model of the lens structure in the training image, the features comprising features extracted using the portion in the defined model indicative of the boundary of the nucleus of the lens structure in the training image; and
(3d) constructing the grading model based on the determined grades of nuclear cataract in the plurality of training images and the extracted features from each training image.

4. A method according to claim 1, wherein step (1ai) further comprises the sub-steps of:
(4i) estimating a center of the lens structure in the image; and
(4ii) constructing the contour around the boundary of the lens structure in the image as an ellipse centered on the estimated center of the lens structure.

5. A method according to claim 4, wherein the sub-step (4i) further comprises the sub-steps of:
(5i) obtaining a first plurality of lines in the image, the first plurality of lines being parallel to each other;
(5ii) clustering a profile through each line of the first plurality of lines to obtain a plurality of clusters;
(5iii) determining a centroid of the largest cluster for each line of the first plurality of lines;
(5iv) calculating a mean of the centroids determined for the first plurality of lines; and
(5v) estimating a first coordinate of the center of the lens structure as the mean of the centroids determined for the first plurality of lines.

6. A method according to claim 5, wherein at least one of the first plurality of lines obtained in sub-step (5i) is a median line through the image.

7. A method according to claim 5, further comprising the sub-steps of:
(7i) obtaining a second plurality of lines in the image, the second plurality of lines being parallel to each other and perpendicular to the first plurality of lines;
(7ii) clustering a profile through each line of the second plurality of lines to obtain a plurality of clusters;
(7iii) determining a centroid of the largest cluster for each line of the second plurality of lines;
(7iv) calculating a mean of the centroids determined for the second plurality of lines; and
(7v) estimating a second coordinate of the center of the lens structure as the mean of the centroids determined for the second plurality of lines.

8. A method according to claim 7, wherein at least one of the second plurality of lines obtained in sub-step (7i) is a line through the estimated first coordinate of the center of the lens structure.

9. A method according to claim 5, further comprising the sub-step of thresholding the image to extract a foreground of the image prior to the sub-step (5i).

10. A method according to claim 9, wherein the sub-step of thresholding the image to extract the foreground of the image, the image comprising a plurality of pixels, further comprises the sub-step of segmenting a percentage of the pixels in the image with highest grey level values.

11. A method according to claim 10, wherein the percentage ranges from 20% to 30%.

12. A method according to claim 7 wherein each cluster comprises a plurality of pixels and the method further comprises the sub-steps of:
(12i) determining the number of pixels in the largest cluster obtained for each of the first and second plurality of lines; and
(12ii) calculating a mean of the number of pixels in the largest clusters obtained for the first plurality of lines and a mean of the number of pixels in the largest clusters obtained for the second plurality of lines; and
in sub-step (4ii), the contour around the boundary of the lens structure is constructed as an ellipse centered on the estimated center of the lens structure, and having a first and second diameter equal to the mean of the number of pixels in the largest clusters obtained for the first and second plurality of lines respectively.

13. A method according to claim 1 wherein the shape model is repeatedly deformed in sub-step (1aii) until a difference between the deformed shape model in a previous iteration and the deformed shape model in a current iteration is below a predetermined value.

14. A method according to claim 3, wherein the shape model is estimated from a plurality of images during the training phase, the plurality of images comprising a sub-set of the plurality of training images.

15. A method according to claim 14, wherein the shape model is estimated from the plurality of images based on the following sub-steps:
(15i) labeling a plurality of landmark points on each of the plurality of images to form a shape on each of the plurality of images, the shape on each of the plurality of images being a training shape;
(15ii) aligning the training shapes to a common coordinates system;
(15iii) calculating parameters describing the shape model based on the aligned training shapes; and
(15iv) determining the shape model from the calculated parameters.

16. A method according to claim 15, wherein the sub-step (15ii) is performed using a transformation which minimizes the sum of squared distances between the plurality of landmark points on different training shapes.

17. A method according to claim 15, wherein the sub-step (15iii) is performed by performing a principal component analysis on the aligned training shapes.

18. A method according to claim 15, wherein the parameters calculated in sub-step (15iii) comprise a set of eigenvectors, the set of eigenvectors corresponding to largest eigenvalues of a covariance matrix of the training shapes.

19. A method according to claim 1, wherein the shape model is described in a shape space and the image is described in an image space; and
the initialization step of the iterative process further comprises the sub-steps of:
setting an initial shape parameter vector and setting an initial pose parameter vector based on the constructed contour in the test image; and
transforming the shape model from the shape space onto the image space based on the initial shape parameter vector and the initial pose parameter vector to produce the initial deformed shape model on the image, the initial deformed shape model on the image comprising a plurality of image landmark points; and
the iterative process further comprises the sub-steps of repeatedly:
(19i) locating a matching point for each image landmark point of the deformed shape model on the image;
(19ii) updating the pose parameter vector using the image landmark points and the respective matching points; and
(19iii) transforming the shape model in the shape space onto the image space in the image using the updated pose parameter vector to produce an updated deformed shape model on the image.

20. A method according to claim 19, wherein the iterative process further comprises the sub-step of updating the shape model in the shape space.

21. A method according to claim 20, wherein the sub-step of updating the shape model in the shape space further comprises the sub-steps of:
(21i) transforming the matching points in the image space onto the shape space using the updated pose parameter vector;
(21ii) updating the shape parameter vector by projecting a subset of the transformed matching points onto the shape space; and
(21iii) updating the shape model in the shape space using the updated shape parameter vector.

22. A method according to claim 21, wherein the sub-step (21ii) further comprises the sub-steps of:
(22i) projecting the transformed matching points onto the shape space to obtain a preliminary update of the shape parameter vector;
(22ii) updating the shape model on the shape space using the preliminary update of the shape parameter vector to obtain a preliminary update of the shape model, the preliminary update of the shape model comprising a plurality of shape landmark points; and
(22iii) obtaining the sub-set of the transformed matching points by excluding a transformed matching point if an Euclidean distance between the transformed matching point and its corresponding shape landmark point is larger than a predetermined value.

23. A method according to claim 19, wherein the sub-step (19i) further comprises the sub-steps of:
(23i) for each image landmark point, calculating a first derivative of an intensity distribution of the image along a profile normal to a boundary of the deformed shape model on the image and passing through the image landmark point; and
(23ii) using the first derivative calculated for each image landmark point to locate a point on an edge of the lens structure in the image as the matching point for the image landmark point.

24. A method according to claim 23, further comprising the sub-step of estimating a matching point of an image landmark point from the matching points of surrounding image landmark points if no matching point is located using the first derivative of the profile for the image landmark point.

25. A method according to claim 23, further comprising the sub-step of estimating a matching point of an image landmark point as the image landmark point if no matching points of the surrounding image landmark points are located using the first derivative of the profile for the surrounding image landmark points.

26. A method according to claim 19, wherein sub-step (19ii) further comprises the sub-steps of:
(26i) deriving an initial weight factor for each image landmark point based on the respective matching point;
(26ii) minimizing a weighted sum of squares measure of differences between the image landmark points and the respective matching points using the initial weight factors to calculate a preliminary update of the pose parameter vector;
(26iii) transforming the shape model in the shape space onto the image space in the image using the preliminary estimate of the pose parameter vector to produce a preliminary updated deformed shape model on the image, the preliminary updated deformed shape model comprising a plurality of updated image landmark points corresponding to the image landmark points with respective matching points;
(26iv) deriving an adjusted weight factor for each updated image landmark point; and
(26v) minimizing the weighted sum of squares measure of differences between the updated image landmark points and the respective matching points using the adjusted weight factors to obtain a final update of the pose parameter vector.

27. A method according to claim 26, wherein the sub-step (26i) further comprises the sub-steps of:
(27i) assigning a first weight factor to an image landmark point if its respective matching point is located on the profile normal to the boundary of the deformed shape model and passing through the image landmark point;
(27ii) assigning a second weight factor to each of the remaining image landmark points, the second weight factor being smaller than the first weight factor.

28. A method according to claim 27, wherein the second weight factor assigned in sub-step (27ii) is set as zero if the matching point of the image landmark point is the image landmark point.

29. A method according to claim 26, wherein the sub-step (28iv) further comprises the sub-steps of setting the adjusted weight factor as a piece-wise reciprocal ratio of an Euclidean distance between the updated image landmark point and the respective matching point.

30. A method according to claim 1 wherein the extracted features of step (1b) comprise one or more of a group of features comprising:
(30i) a mean intensity inside the defined model of the lens structure;
(30ii) a mean color inside the defined model of the lens structure;
(30iii) an intensity ratio between the nucleus of the lens structure and the lens structure;
(30iv) an intensity of a sulcus in the image;
(30v) an intensity ratio between the sulcus in the image and the nucleus of the lens structure;
(30vi) an intensity ratio between an anterior lentil and a posterior lentil in the image; and
(30vii) a color on a posterior reflex in the image.

31. A method according to claim 30, wherein the features (30i) to (30ii) are calculated by averaging measurements of the intensity and color within the defined model of the lens structure.

32. A method according to claim 30, wherein the feature (30vi) is calculated using the sub-steps of:
(32i) obtaining a visual axis profile of the lens structure based on an intensity distribution on a horizontal line through a central posterior reflex in the image;
(32ii) smoothing the visual axis profile using a low-pass Chebyshev filter;
(32iii) locating an anterior lentil edge and a posterior lentil edge in the image by edge detection; and
(32iv) calculating the feature (30vi) based on the smoothed visual profile and the located anterior lentil edge and posterior lentil edge.

33. A method according to claim 30, wherein the feature (30iv) is calculated using the sub-steps of:
(33i) defining a horizontal position of the sulcus as a median point of nucleus edges; and
(33ii) calculating the feature (30iv) based on the horizontal position of the sulcus.

34. A method according to claim 1 wherein the extracted features of step (1b) comprise one or more of a group of features comprising:
(34i) a mean entropy inside the defined model of the lens structure;
(34ii) a mean neighborhood standard deviation inside the defined model of the lens structure;
(34iii) a mean intensity inside the portion indicative of the boundary of the nucleus of the lens structure;
(34iv) a mean color inside the portion indicative of the boundary of the nucleus of the lens structure;
(34v) a mean entropy inside the portion indicative of the boundary of the nucleus of the lens structure;
(34vi) a mean neighborhood standard deviation inside the portion indicative of the boundary of the nucleus of the lens structure; and
(34vii) a strength of a nucleus edge of the lens structure.

35. A method according to claim 34, wherein the features (34i) to (34ii) are calculated by averaging measurements of the entropy and the neighborhood standard deviation within the defined model of the lens structure.

36. A method according to claim 34, wherein the features (34iii)-(34vi) are calculated by averaging measurements of the intensity, color, entropy and neighborhood standard deviation within the portion indicative of the boundary of the nucleus of the lens structure.

37. A method according to claim 34, wherein the feature (34vii) is calculated using the sub-steps of:
(37i) obtaining a visual axis profile of the lens structure based on an intensity distribution on a horizontal line through a central posterior reflex in the image;
(37ii) smoothing the visual axis profile using a low-pass Chebyshev filter;
(37iii) locating an anterior lentil edge and a posterior lentil edge in the image by edge detection; and
(37iv) calculating the feature (33vii) based on the smoothed visual profile and the located anterior lentil edge and posterior lentil edge.

38. A method according to claim 1, wherein the step (1c) is performed using a support vector machine.

39. A method according to claim 1, wherein the test image is a slit-lamp image.

40. A computer system having a processor arranged to perform a method comprising:
(40a) defining a model of a lens structure in the test image based on the following sub-steps, the defined model of the lens structure comprising a portion indicative of a boundary of a nucleus of the lens structure in the test image
(40ai) constructing a contour around a boundary of the lens structure in the test image;
(40aii) repeatedly deforming a shape model in an iterative process to define the model of the lens structure in the test image
wherein the shape model comprises a first portion indicative of a boundary of a lens structure and a second portion indicative of a boundary of a nucleus of the lens structure in the first portion; and
wherein sub-step (40aii) comprises an initialization step of producing an initial deformed shape model on the test image by fitting the first portion of the shape modal to the constructed contour in the test image, thereby fitting the second portion of the shape model to the boundary of the nucleus of the lens structure in the test image;
(40b) extracting features from the test image based on the defined model of the lens structure in the test image, the features comprising features extracted using the portion in the defined model indicative of the boundary of the nucleus of the lens structure in the test image; and
(40c) determining the grade of nuclear cataract in the test image based on the extracted features and a grading model.

41. A computer program product, readable by a computer and containing instructions operable by a processor of a computer system to cause the processor to perform a method comprising:
(41a) defining a model of a lens structure in the test image based on the following sub-steps, the defined model of the lens structure comprising a portion indicative of a boundary of a nucleus of the lens structure in the test image
(41 ai) constructing a contour around a boundary of the lens structure in the test image;
(41aii) repeatedly deforming a shape model in an iterative process to define the model of the lens structure in the test image
wherein the shape model comprises a first portion indicative of a boundary of a lens structure and a second portion indicative of a boundary of a nucleus of the lens structure in the first portion; and
wherein sub-step (41aii) comprises an initialization step of producing an initial deformed shape model on the test image by fitting the first portion of the shape modal to the constructed contour in the test image, thereby fitting the second portion of the shape model to the boundary of the nucleus of the lens structure in the test image;
(41b) extracting features from the test image based on the defined model of the lens structure in the test image, the features comprising features extracted using the portion in the defined model indicative of the boundary of the nucleus of the lens structure in the test image; and
(41c) determining the grade of nuclear cataract in the test image based on the extracted features and a grading model.
